(19) United States
(12) Patent Application Publication
(10) Pub. No.: US 2013/0057885 A1
(43) Pub. Date: Mar. 7, 2013

(54) Printing System, POS System, Connection Device, Control Method of Printing System, and Program Therefor

(71) Applicant: SEIKO EPSON CORPORATION, Tokyo (JP)

(72) Inventor: Masahiro MINOWA, Hata-machi (JP)

(73) Assignee: SEIKO EPSON CORPORATION, Tokyo (JP)

(21) Appl. No.: 13/649,017

(22) Filed: Oct. 10, 2012

Related U.S. Application Data
(63) Continuation of application No. 11/913,152, filed on Oct. 30, 2007.

(30) Foreign Application Priority Data
May 17, 2005 (JP) 2005-143544

(51) Int. Cl. H04N 1/60; G06K 15/02

(52) U.S. Cl. 358/1.9; 358/1.15

(57) ABSTRACT

A printing system has an interface unit (51) receivable for the first printing data for printing settlement-processing information and the second data for printing advertising and sales promotion information, and a plurality of printing apparatuses (50a, 50b) for print processing data obtained via the interface unit (51). When the interface unit (51) receives the first printing data, it transmits to the predetermined first printing apparatus (50a) among a plurality of printing apparatuses. When the interface unit (51) receives the second printing data, it determines if the second printing data is printable or not by the first printing unit (50a) and transmits the second printing data to the first printing unit (50a) or the second printing unit (50b) based on the determination result.

### TECHNICAL FIELD

The present invention relates to: a printing system made up of a terminal computer for generating first print data inclusive of settlement information, an information-providing server for generating second print data to be generated based on a result of analyzing the settlement information, an interface unit capable of receiving the first print data and the second print data, and a plurality of printing apparatuses for performing print processing of data obtained through the interface unit; a POS system; a connection device; a control method of a printing system; and a program therefor.

### BACKGROUND ART

In retail business such as in a supermarket, a convenience store, and the like, there has widely been used a POS system (point-of-sale information control system) which is capable of printing on a receipt advertising and sales promotion information relating to bargain-sale commodities, events, and the like, in addition to so-called settlement information relating to purchased commodities and their prices. Recently, there has also been a case in which an exclusively used system (also referred to as an exclusive system) is introduced for issuing not only advertising and sales promotion information but also coupons and rots in order to add sales promotion information thereto. The exclusive system serves an effective advertising means for sales promotion and serves the purpose of an effective advertising means in promoting the sale.

This kind of POS system is ordinarily made up by connection: to a POS server which has a master list of commodities and performs an overall control over a plurality of POS servers; and also to an information-providing server which provides advertising and sales promotion information. In performing settlement processing, input information (commodity code) inputted by scanning a bar code which is attached to the commodity to be purchased by a customer is transmitted to the POS server. Settlement information to be printed on a receipt is generated by extracting, from the master list of commodities inside the POS server, the commodity data such as the name, price, and the like of the commodity relating to the input information. The POS server or the POS terminal obtains the input information and, at the same time, also transmits the input information to the information-providing server. The information-providing server extracts the advertising and sales promotion information relating to the settlement information (e.g., commodity item to be settled by payment) for further transmission to the POS server or the POS terminal. Print data is generated based on the settlement information and the advertising and sales promotion information. The settlement information print data is transmitted to the printing apparatus which is used to print the settlement information print data, and the advertising and sales promotion information print data is transmitted to the printing apparatus which is used to print the advertising and sales promotion advertising data. A settlement information receipt and an advertising and sales promotion information ticket (e.g., a coupon ticket) are thus issued (see, e.g., JP-T-2003-500767, FIG. 2, etc.)

### DISCLOSURE OF INVENTION

Recently, there can be seen a POS system which, out of a desire on the part of a retail business to print in color advertising and sales promotion information, introduces therein a color printing apparatus which is used for issuing advertising and sales promotion tickets. However, the color printing apparatus in general employs a construction and processing in which printing of a plurality of colors is processed. Therefore, as compared with a black-and-white printing apparatus in which only processing of printing a single color may be performed, there was a problem in that the color printing apparatus tends to be lower in the processing speed. Even in case the advertising and sales promotion information is printed in a mode other than in color printing, there was a problem in that the tact time required for processing in issuing receipts and tickets becomes relatively long as a whole.

Therefore, the invention has an object of materializing a printing system, a POS system, a connection device, a control method of a printing system, and a program therefor which can efficiently provide the customer with an advertising and sales promotion information.

A printing system according to the invention comprises: a terminal computer for settlement processing; an information-providing server an interface unit; and a plurality of printing apparatuses capable of performing print processing for printing, on paper, data obtained through said interface unit. The terminal computer comprises: a first print data generating part which generates first print data including settlement information; and a first print data transmitting part which transmits the first print data generated to the interface unit. The information-providing server comprises: a second print data generating part which generates second print data when, upon analyzing the settlement information to search whether predetermined information is included or not, the predetermined information is included; and a second print data transmitting part which transmits the second print data generated to the interface unit. The interface unit comprises: a first print data processing part which transfers, to a first printing apparatus, the first print data received from the terminal computer, as it is or with a predetermined data processing; and a second print data processing part which transfers the second print data to either the first printing apparatus or the second printing apparatus, depending on a result of analysis of the second print data received from the information-providing server.

Further, according to another aspect of the invention, a control method of a printing system comprising: a terminal computer for settlement processing; an information-providing server; an interface unit; and a plurality of printing apparatuses capable of performing print processing in which data obtained through said interface unit is printed on paper, wherein the method comprises: a step for the terminal computer to generate first print data inclusive of settlement information and to transmit the data to the interface unit; a step for the interface unit to transfer to a first printing apparatus, the first print data received from the terminal computer as it is or with predetermined data processing; a step for the information-providing server to search whether predetermined information is included or not by analyzing the settlement-processing information and, in case the predetermined information is included, to generate the second print data for transmission to the interface unit; and a step for the interface unit to analyze the second print data received from the information-providing server and, depending on the result, to transmit the second print data to one of the first printing apparatus and the second printing apparatus.

According to these arrangements, the interface unit analyzes the second print data received from the information-providing server. If a judgment is made that the second print data can be printed in the first printing apparatus, the second print data is transmitted to the first printing apparatus. If a judgment is made that printing cannot be made in the first printing apparatus, the second print data is transmitted to the second printing apparatus which is other than the first printing apparatus. Therefore, not only the first print data but also the second print data can be printed in the first printing apparatus to the extent possible. In other words, by ordinarily setting a printing apparatus which has a high processing efficiency (high in printing speed) as the first printing apparatus among the plurality of printing apparatuses, an overall tact time required for the print processing of the first print data and the second print data can be shortened. In the end, the advertising and sales promotion information can be efficiently provided to the customers. The second print data may be printed in the predetermined printing apparatus other than the first printing apparatus among the plurality of printing apparatuses. Alternatively, at the point of time when the interface unit transfers the second print data, selection may be made of any printing apparatus other than the first printing apparatus. In this case, the interface unit may be so arranged that the status of the printing apparatus that is connected thereto is kept monitored and that, depending on the result of monitoring, the second print data is transferred, or that the second print data is transferred in accordance with the predetermined priority order.

In the above-described printing system, the interface unit is preferably mounted on the first printing apparatus and comprises a communication port to communicate with either the second printing apparatus or the information-providing server.

According to this arrangement, the printing system of the invention can be easily constituted only by mounting the interface unit on the first printing apparatus. The first printing apparatus is preferably provided with a mounting part (mounting slot) for mounting the interface unit thereon.

In the above-described printing system, preferably, the first printing apparatus is a black-and-white printing apparatus which performs black-and-white printing, and the second printing apparatus is a color-printing apparatus which is capable of performing color printing in two colors or more. The second print data processing part transfers the second print data to the black-and-white printing apparatus, when a result of analysis of the second print data shows black-and-white print data, and transfers the second print data to the color-printing apparatus, when the result shows color print data.

A color-printing apparatus ordinarily has a construction and processing to perform print processing of a plurality of colors which is more than the color of a black-and-white printing apparatus. Therefore, as compared with the black-and-white printing apparatus for performing only a single-color print processing, the processing speed of the color-printing apparatus is likely to be low. In this arrangement, however, when the second print data is of black-and-white print data, i.e., when color printing is found unnecessary as a result of analysis of the print data, the first printing apparatus, which is black-and-white printing apparatus, performs also the printing of the second print data. As a result, the tact time required for the print processing of the first print data and the second print data can be shortened.

In the above-described printing system, preferably, the first printing apparatus is capable of printing in two colors or less and the second printing apparatus is capable of printing in three colors or more. The second print data processing part: transfers the second print data to the first printing apparatus, when the result of analysis of the second print data shows print data of two colors or less; and transfers the second print data to the second printing apparatus, when the result of analysis shows print data of three colors or more.

Normally, the printing speed is lower with a larger number of colors, e.g., printing in three colors or more (full color) is lower in processing speed than printing in two colors or less. According to this arrangement, however, in case the second print data is of two colors or less, the printing of the second print data is also performed in the first printing apparatus which performs the printing in less than two colors. As a result, the overall tact time required for printing the first print data and the second print data can be shortened.

In the above-described printing system, preferably, the first print data contains a paper-cutting command which orders to cut the paper. The first printing apparatus and the second printing apparatus comprise a paper-cutting mechanism which cuts the paper upon receipt of the paper-cutting command. When the first print data processing part detects the paper-cutting command in the first print data, the first print data processing part extracts and temporarily retains the paper-cutting command. When the second print data is transferred to the first printing apparatus based on a result of analysis of the second print data, the second print data processing part transfers the second print data to the first printing apparatus by adding the paper-cutting command to a back-end of the second print data. When the second print data is transferred to the second printing apparatus based on a result of analysis of the second print data, the first print data processing part transfers the paper-cutting command to the first printing apparatus and the second print data processing part transfers the second print data to the second printing apparatus by adding the paper-cutting command to the back-end of the second print data.

According to this arrangement, in case the second print data is transferred to the first printing apparatus, the paper-cutting command is added to the back-end of the second print data. Therefore, it becomes possible to print the first print data and the second print data in succession and to further automatically cut the back-end of the paper. As a result, the operator who operates the terminal computer and the printing apparatus has only to hand over to the customer a piece of automatically cut paper, thereby reducing the load of the operator. Further, in case the second print data is transferred to the second printing apparatus, the paper-cutting command is transferred to the first printing apparatus and the paper-cutting command is added to the back-end of the second print data. Therefore, even in case the printing is performed in two printing apparatuses, a piece of automatically cut paper in a suitable manner can be issued from both of the printing apparatuses, respectively.

Preferably, in the above-described printing system, when the second print data is transferred to the first printing apparatus based on the result of analysis of the second print data, the second print data processing part adds, at the head of the second print data, a partition-line-print data for printing a partition line in a width direction of the paper.

According to this arrangement, in case the second print data is transferred to the first printing apparatus, the first print data and the second print data will be printed in succession. At this time, by printing the partition line, the border between the first print data and the second print data can be clearly shown.

In the above-described printing system, preferably the terminal computer sets different transaction numbers with respect to the respective settlements, thereby producing the first print data inclusive of the transaction number. The first print data processing part transfers the first print data inclusive of the transaction number to the first printing apparatus along with extracting and temporarily retaining the transaction number. The second print data processing part incorporates data for printing the transaction number, into the second print data.

According to this arrangement, the interface unit transfers the first print data inclusive of the transaction number to the first printing apparatus, and also extracts the transaction number contained in the first print data, and temporarily retains thereof and incorporates, into the second print data as received from the IP server, the data for printing the transaction number. Therefore, also in case the first print data and the second print data are printed by separate printing apparatus, or in case both the data are printed in the same printing apparatus though in a divided state, it is possible to correspondingly locate the paper on which the first print data is printed and the paper on which the second print data is printed, by means of the transaction numbers. As a result, even in an arrangement in which the second printing apparatus, for example, is disposed at a position remote from the first printing apparatus so that the paper (advertising and sales promotion information) to be issued by the second printing apparatus is to be received by the customer, the operator can be prevented from wrongly handing over another customer's paper or (in an arrangement in which the customer receives the paper by himself) the customer can be prevented from picking up a wrong paper, by confirming whether the transaction number coincides with each other or not.

In the above-described printing system, preferably, the interface unit further comprises a status-checking part for monitoring a status as to whether the plurality of printing apparatuses are working normally or not, and the first print data processing part and/or the second print data processing part transfers, based on the result of monitoring by the status-checking part, a print data to either the fist printing apparatus or the second printing apparatus, whichever is working normally.

According to this arrangement, when a judgment is made that the first printing apparatus and/or the second printing apparatus is not operating normally, the print data is transferred to the other printing apparatus. Therefore, even in case there is a trouble with the first printing apparatus or the second printing apparatus, print processing of the first print data and the second print data can be continued without problem.

In the above-described printing system, when data to be transferred is color print data and also when the printing apparatus to which the color print data is transferred does not comply with the color printing, preferably the first print data processing part and/or the second print data processing part converts the color print data to black-and-white print data.

According to this arrangement, in case a color printing apparatus and a black-and-white printing apparatus are included among the plurality of printing apparatuses, and even in case the printing apparatus to which the color print data is transferred is a black-and-white printing apparatus, print processing can be performed as the black-and-white print data.

In the above-described printing system, preferably the first print data processing part transfers the first print data received from said terminal computer to the information-providing server through the communication port, and the second print data generating part analyzes the settlement information included in the first print data transferred from the interface unit.

According to this arrangement, transferring of the first print data to the information-providing server is performed by the interface unit. Therefore, only by introducing the interface unit, the printing function of the advertising and sales promotion information can be added without the necessity of modification to the terminal computer or of change to the application.

The printing system according to another aspect of the invention comprises: an interface unit having mounted thereon a communication port which is capable of receiving first print data having specified no printing apparatus to which the first print data is to be output and second print data having specified no printing apparatus to which the second print data is to be output; and a plurality of printing apparatuses for performing print processing of data obtained through the interface unit. The interface unit further comprises: a first print data processing part which transfers to a first printing apparatus, the first print data received as it is or with specified data processing; and a second print data processing part which transfers the second print data to either the first printing apparatus or a second printing apparatus, depending on a result of analysis of the second print data received.

According to another aspect of the invention, there is provided another control method of a printing system. The printing system comprises: an interface unit having mounted thereon a communication port which is capable of receiving first print data having specified no printing apparatus to which the first print data is to be output and second print data having specified no printing apparatus to which the second print data is to be output; and a plurality of printing apparatuses for performing print processing of data obtained through said interface unit, The method comprises for the interface unit to perform: a step of transferring the first print data received to the first print apparatus as it is or with predetermined data processing; and a step of transferring the second print data to either the first printing apparatus or the second printing apparatus which is other than the first printing apparatus depending on a result of analysis of the second print data received.

According to these arrangements, the interface unit analyzes the second print data received from the information-providing server. If a judgment is made that the second print data can be printed in the first printing apparatus, the second print data is transmitted to the first printing apparatus. If a judgment is made that printing cannot be made in the first printing apparatus, the second print data is transmitted to the second printing apparatus which is other than the first printing apparatus. Therefore, not only the first print data but also the second print data can be printed in the first printing apparatus to the extent possible. In other words, by ordinarily setting a printing apparatus which has a high processing efficiency (high in printing speed) as the first printing apparatus among the plurality of printing apparatuses, an overall tact time required for the print processing of the first print data and the second print data can be shortened. In the end, the advertising and sales promotion information can be efficiently provided to the customers. The second print data may be printed in the predetermined printing apparatus other than the first printing apparatus among the plurality of printing apparatuses. Alternatively, at the point of time when the interface unit transfers the second print data, selection may be made of any printing apparatus other than the first printing apparatus. In this case, the interface unit may be so arranged that the status of the printing apparatus that is connected thereto is kept monitored and that, depending on the result of monitoring, the second print data is transferred, or that the second print data is transferred in accordance with the predetermined priority order.

According to another aspect of the invention, a POS system comprises: the printing system according to any of the above; and a POS server which is connected to a plurality of the terminal computers and which controls the plurality of the terminal computers.

According to this arrangement, there can be materialized a POS system in which the first print data inclusive of the settlement information, and the second print data inclusive of the advertising and sales promotion information can be efficiently printed.

A connecting device of the invention comprises: a communication port which serves as the interface unit in the printing system according to any one of the above and having a communication port which communicates with at least either the plurality of printing system or the information-providing server.

By using this connecting device, there can be arranged a printing system which can shorten an overall tact time required for print processing of the first print data and the second print data.

According to another aspect of the invention, a program causes a computer to perform each of the steps of the above-described method for controlling the printing system.

By performing this program, there can be arranged a printing system which can shorten an overall tact time required for print processing of the first print data and the second print data.

### BRIEF DESCRIPTION OF DRAWINGS

FIG. 1 is a configuration diagram of a POS system relating to one embodiment of the invention.

FIGS. 2A and 2B are outside perspective views of POS terminals.

FIG. 3 is an outside perspective view of an interface unit.

FIG. 4 is a function block diagram of a terminal computer, an IP server, and a printing apparatus.

FIG. 5 is a function block diagram of the interface unit.

FIG. 6 is a control block diagram of the interface unit.

FIG. 7 is a flow chart showing the processing in the interface unit when data is received from a host interface.

FIG. 8 is a flow chart showing the processing in the interface unit when data is received from the IP server.

FIG. 9 is an illustration showing an example of the result of printing of a receipt and a coupon.

FIG. 10 is an illustration showing the result of printing of receipt and coupon.

FIG. 11 is another example of an illustration showing the result of printing of receipt and coupon.

### BEST MODE OF CARRYING OUT THE INVENTION

A description will now be made, with reference to the accompanied drawings, about a printing system, a POS system, a connection device, a control method of the printing system, and a program therefor relating to the invention.

The invention relates to a printing system having at least: an interface unit (interface apparatus) which is capable of receiving first print data and second print data which are two data with different characteristics; and a plurality of printing apparatuses which perform print processing of data obtained through the interface unit. When the first print data is received, the interface unit transfers the first print data to the first printing apparatus which is a predetermined printing apparatus among the plurality of printing apparatuses, the transferring of the first print data being made as it is or with due processing (i.e., with or without processing). When the second print data is received, the second print data is analyzed and, if the printing can be made in the first printing apparatus, is transferred to the first printing apparatus and, if the printing in the first printing apparatus is impossible, is transferred to the second printing apparatus which is other than the first printing apparatus. Now, a POS system which is used in stores such as super markets, convenience stores, and the like is taken as an example to describe in detail about a terminal apparatus (terminal computer), an information-providing server (hereinafter referred to as an Information Providing Server (hereinafter referred to as an IP server), an interface unit and a printing system having a printing apparatus, a connection device (interface unit), and a control method of the printing system, all of which are applied to the POS system.

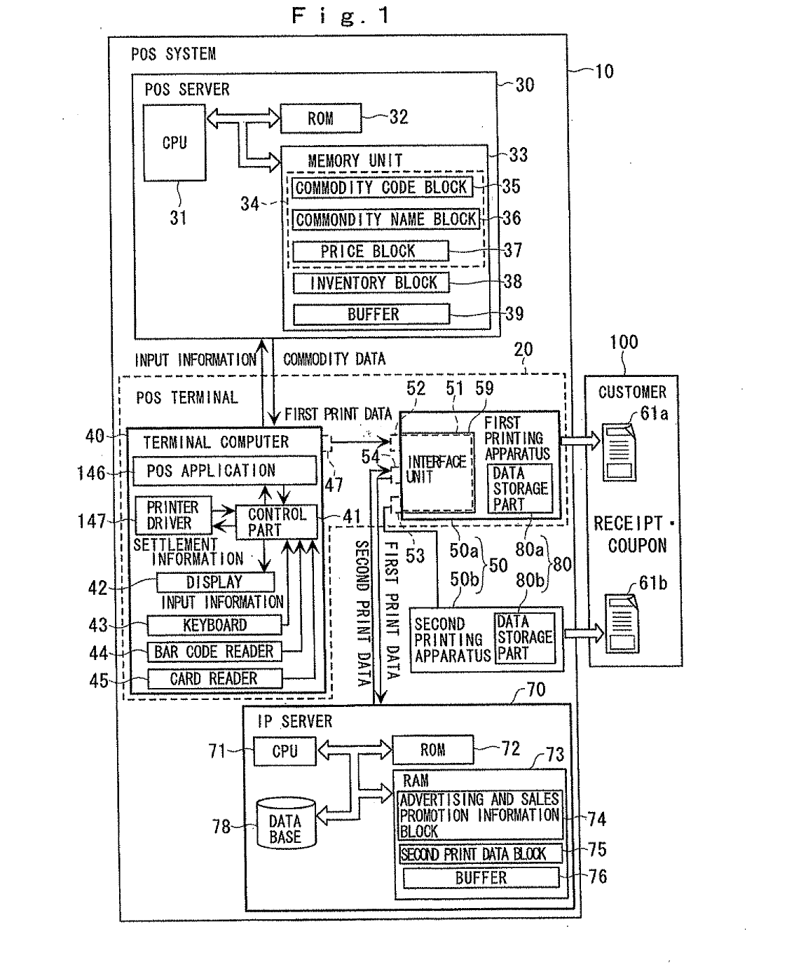

As shown in FIG. 1, the POS system 10 according to the invention is made up of a plurality of POS terminals 20 (only one is represented) which obtains input information relating to the commodity as a result of reading, by an operator (user) with a bar code reader 44, of a bar code adhered to or printed in advance on the commodity; and a POS server 30 which is mutually connected to the POS terminal through a network and which performs control over the input information inputted to the POS terminal 20.

The POS server 30 has a ROM 32 and a memory part 33 (RAM, hard disk drive, and the like), in addition to a CPU 31 (control unit), and performs processing of the information stored in a buffer 39, and the like inside the memory part 33 according to a control program stored in the ROM 32. In particular, the memory part 33 contains therein a commodity code block 35, a commodity name block 36, a price block 37, and an inventory block 38. Based on the input information transmitted from the POS terminal 20, the CPU 31 extracts from the above-described blocks the information relating to the commodity code, commodity name, and commodity price. There is thus generated commodity data for use in printing on a receipt (first print data) and for use in displaying on a display 42 of the POS terminal 20. The term “commodity code” represents data which forms the basis for the first print data (settlement-processing information) which is printed on a piece of paper 61a (hereinafter simply referred to as “a paper”) to be used as the receipt. In addition, the commodity code block 35, the commodity name block 36 and the price block 37 are made up of a look-up table 34 ordinarily referred to as a commodity master.

On the other hand, the POS terminal 20 is provided with: the terminal computer 40 which refers to the commodity master (look-up table) 34 inside the POS server 30 and also obtains the commodity data from the POS server 30; the first printing apparatus 50a which performs printing of the first print data mainly containing therein the settlement information; and the second printing apparatus 50b which performs printing of the second printing information mainly containing therein the advertising and sales promotion information obtained mainly from the IP server 70 which is described in detail hereinafter. The terminal computer 40 and the interface unit (interface apparatus) 51, as well as the interface unit 51 and the second printing apparatus 50b are respectively connected to each other through connectors (not shown). In this embodiment the explanation is made on the assumption that: the first printing apparatus 50a is of a thermal printer for performing black-and-white printing and is defined to be disposed near the operator operating the POS terminal 20; and that the second printing apparatus 50b is of an ink jet printer for performing color printing disposed on a line of movement of the customer 100 who has finished the settlement processing with the POS terminal 20 so that the paper 61b discharged from the printing apparatus in question can be received by the customer 100. It may, of course, be so arranged that the operator hands over the paper 51b to the customer 100

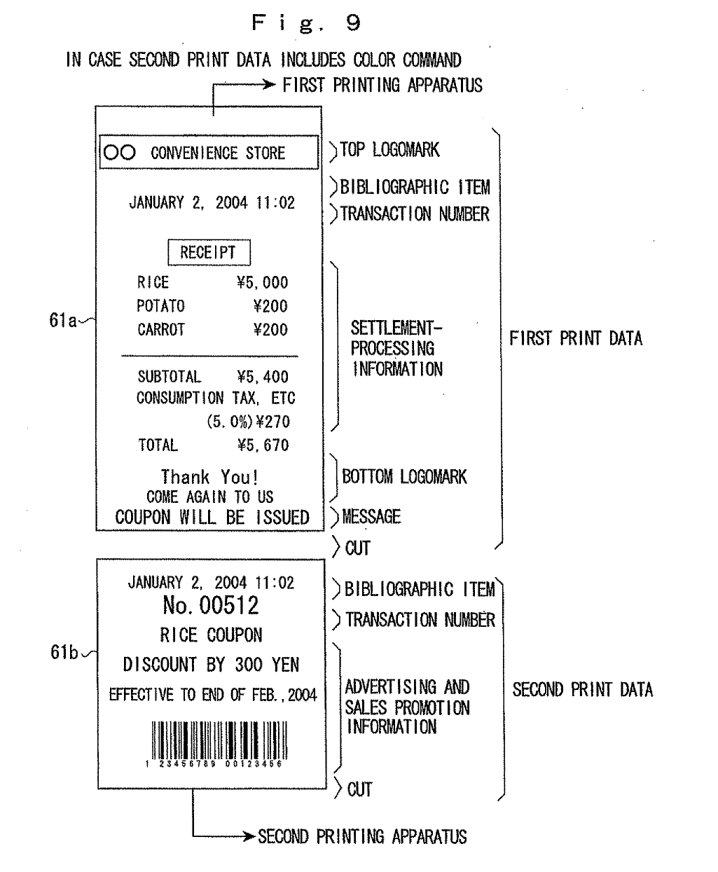

The terminal computer 40 is provided with: a POS application for performing the settlement processing; a printer driver 147 for performing the print control of the printing apparatus 50; a control part 41 for performing the control of the entire terminal computer 40; and the like, The control part 41 obtains the commodity data relating to the commodity code, commodity name, price thereof, and the like from the POS server 30 by reading the bar code through inputting from the keyboard 43 or through reading with a bar code reader 44. The control part 41 reads a credit card or a membership card of the customer 100 with a card reader 45, thereby obtaining the inputted information relating to the member, such as the information relating to the credit settlement, membership number, and the like. In addition, the control part 41 sets a transaction number (series of settlement numbers, see FIG. 9) which varies from settlement processing to settlement processing, in cooperation with a POS application 146, thereby generating credit settlement information based on the commodity data transmitted from the POS server 30. In addition, the control part 41 generates the first print data inclusive of the settlement-processing information, based on the commodity data transmitted from the POS server 30, and transmits the first print data to the first printing apparatus 50a (interface unit 51) through the printer driver 147. Further, the control part 41 displays the generated settlement-processing information on the display 42, thereby presenting to the operator or the customer 100 the purchased commodity name and a total amount to be paid for the purchased commodity. Since the transaction number is extracted or the print data is analyzed by the IP server 70, the first print data to be transmitted from the terminal computer 40 must be of a text form or of an XML form, HTML form so that the contents of the print data can be interpreted.

The first printing apparatus 60a is provided with the interface unit 51 having mounted thereon: a host interface 52 to be connected to the terminal computer 40; an IP server interface 54 to be connected to the IP server 70; and a printing apparatus interface 53 to be connected to the second printing apparatus 50b. The interface unit 51 is arranged to be detachable on a mounting slot 59 in a main body of the first printing apparatus 50a.

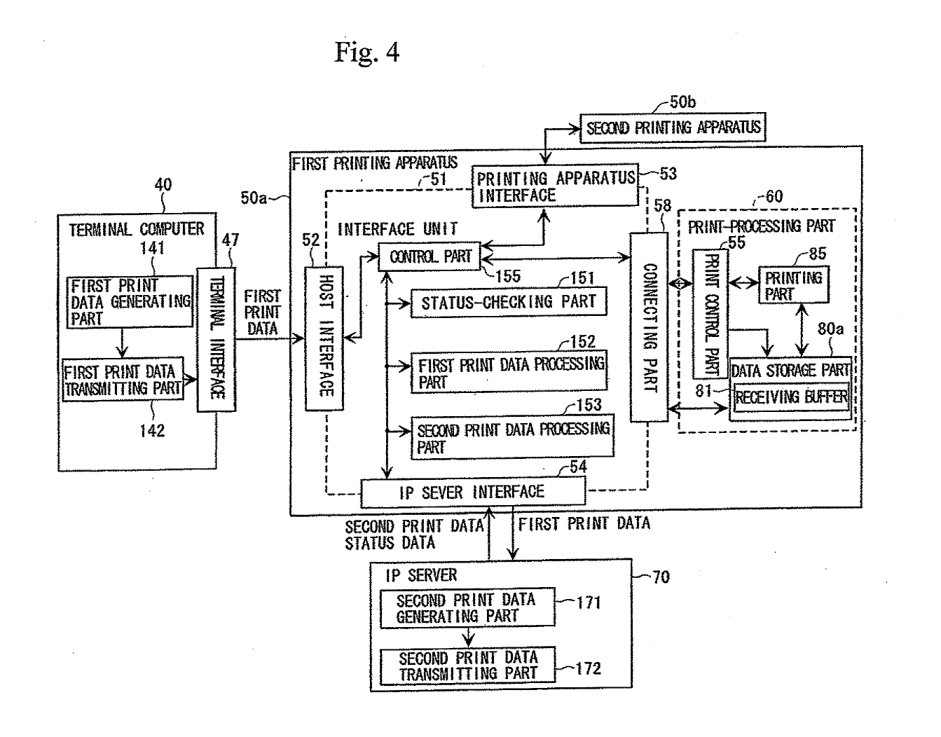

The interface unit 51: gives printing instruction to the print-processing part 60 (comprising printing part 85, data storage part 80a, print control part 55, and the like, see FIG. 4) to the effect that the printing be made of the first print data obtained from the terminal computer 40; and analyzes the second print data received from the IP server 70 and, depending on the analysis result, gives printing instruction of the second print data to the print-processing part 60 or to the second printing apparatus 50b. In particular, analysis is made as to whether there is contained in the second print data a command to show the color print data (hereinafter referred to as a “color command”). If such a command is contained, the printing command of the second print data is given to the second printing apparatus 50b and, if such a command is not contained, the above-described printing command is given to the print-processing part 60.

Further, the interface unit 51 monitors the state (status) of the print-processing part 60 (first printing apparatus 50a) or of the second printing apparatus 50b to judge whether it is available for printing. Depending on the result of judgment, in case judgment is made that the printing is not available, alternative printing is performed with the other printing apparatus. When alternative printing is made, in case the second print data contains therein color print data, the color print data is converted to black-and-white print data, thereby printing command is made to the print-processing part 60. Further, extraction is made of bibliographical matters (for information relating to the date and time, and the like; see FIG. 9, and the like) and the transaction number out of the first print data received from the terminal computer 40 to thereby perform the processing such as to combine the data into the second print data.

The printing apparatus 50a, 50b is each provided with a data storage part 80a, 80b which is each provided with a receiving buffer 81 (see FIG. 4) which temporarily stores therein print data and various control commands. The printing apparatus 501, 50b is performs various processing such as print processing and sheet cutting processing based on print command and command processing order by means of print data and various control commands stored in the receiving buffer 81, thereby issuing receipts (paper having printed thereon the first print data) and coupons (paper having printed thereon the second print data) as shown in FIG. 9.

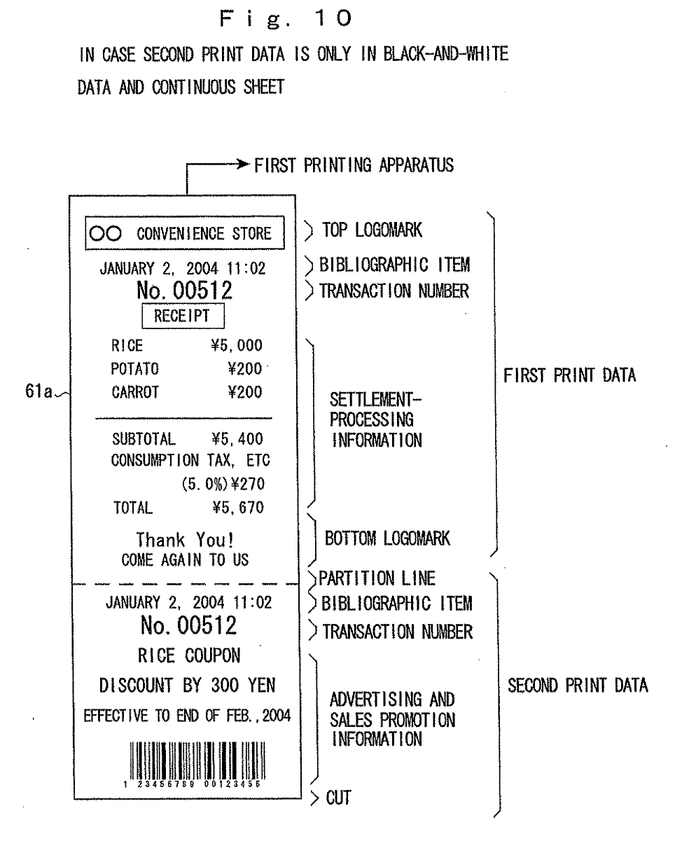

FIG. 9 shows an example of a receipt 61a which is issued by the first printing apparatus 50a in case the color print data is included in the second print data, as well as an example of a coupon 61b which is issued by the second printing apparatus 50b. In this manner, the receipt 61a is issued based on the first print data which is made up of a top logo, bibliographical matter, transaction number and transaction information (inclusive of commodity name and its price, as well as total price, and the like), bottom logo, message, cutting command, and the like. The coupon 61b, on the other hand, is issued based on the second print data which is made up of a bibliographical matter, transaction number, advertising and sales promotion information (inclusive of a discount coupon and a bar code to be read by a bar code reader 44 in case a discount coupon is used; advertising of event information, and the like; URL making public such event information; QR code for making access to the URL; and the like), cutting command, and the like. In case color print data is not included, the receipt and the coupon are issued consecutively by the first printing apparatus 50a, and there is printed a demarcation line (e.g., a dotted line) showing the border between the first print data and the second print data (see FIG. 10). The receipt and/or coupon issued by the first printing apparatus 50a are handed over to the customer 100 by the operator. The coupon to be issued by the second printing apparatus 50b, on the other hand, is personally received by the customer 100.

The second printing apparatus 50b is so arranged that setting can be made between a color printing mode by means of dip switch, memory switch, and the like, and a black-and-white printing mode. The information about this mode setting is received by the interface unit 51. In case the mode is set to the black-and-white printing mode, both the first print data and the second print data are transferred to the first printing apparatus 50a. In case the mode is set to the color mode, the second print data is transferred to the second printing apparatus 50b only when color command is included in the second print data. Further, the first print data is transferred to the first printing apparatus 50a regardless of the mode setting of the second printing apparatus 50b and the content of the second print data. In other words, the first printing apparatus 50a and the second printing apparatus 50b have priority order depending on the processing speed and processing capability (in this embodiment, the first printing apparatus 50a is given priority). The second print data is transferred to a suitable printing apparatus to suit the priority order.

On the other hand, as shown in FIG. 1, the IP server 70 is made up of a memory such as a ROM 72, RAM 73, and the like as well as a data base 78, aside from a CPU 71 (control unit). According to the control program stored in the ROM 72, there is performed the processing of the information stored in the buffer 76, and the like in the RAM 73. Particularly, the RAM 73 has therein: an advertising and sales promotion information block 74 having stored therein advertising and sales promotion information table which is used in generating the second print data depending on the content of the first print data; and a second print data block 75 which stores therein the generated second print data. The CPU 71 generates the second print data by referring to the advertising and sales promotion information table in question based on the first print data received from the terminal computer 40 through the interface unit 51, and also transmits the generated second print data to the interface unit 51. The CPU 71 also stores the generation history of the generated second print data into the data base 78. This generation history is used, when the second print data is, e.g., data for printing a discount coupon, as a record to testify that the discount coupon is issued not for incorrect purposes.

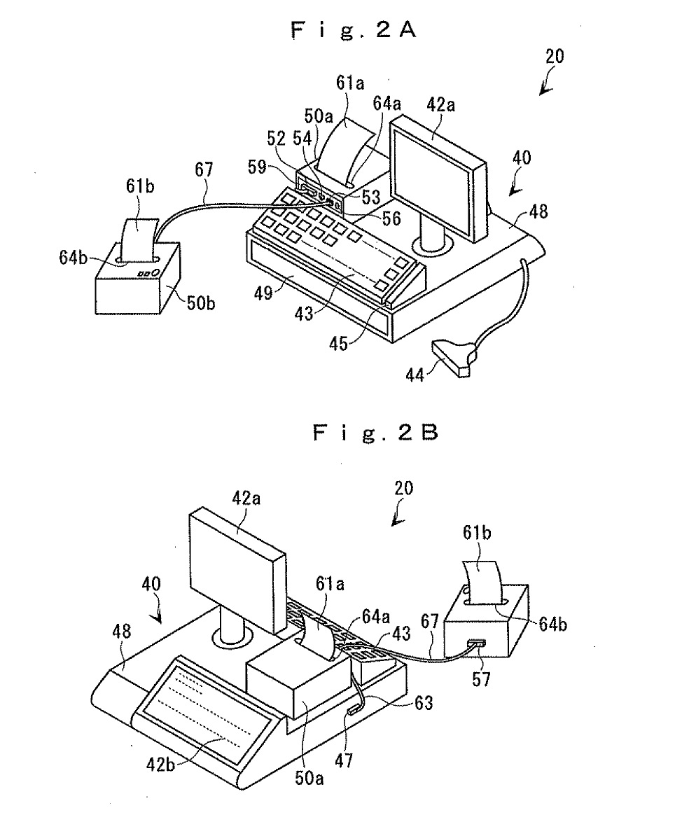

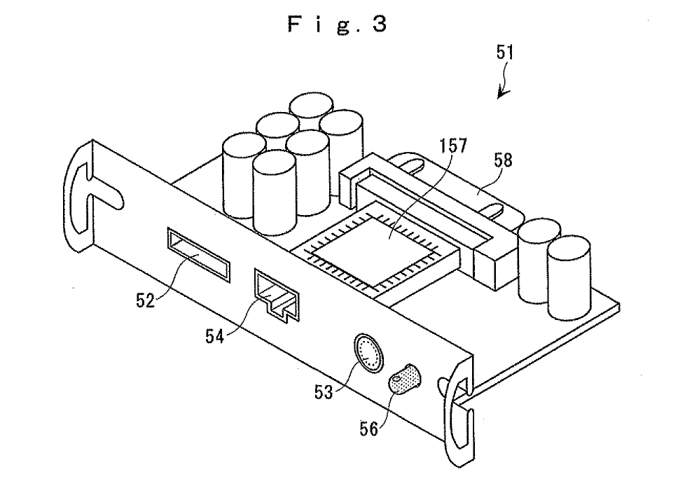

A description will now be made about the arrangement of the POS terminal 20 with reference to FIGS. 2A and 2B as well as FIG. 3. FIG. 2A is a front perspective view of the POS terminal 20 as seen from the operation side by the operator, and FIG. 2B is a rear perspective view thereof as seen from the customer side. As shown in FIGS. 2A and 2B, the POS terminal 20 is made up of: the terminal apparatus (terminal computer) 40 whose main part is formed by a box-shaped main body case 48; the first printing apparatus 50a which is disposed on the left rear side of the main body case 48; and the second printing apparatus Sob which is disposed in a position apart from the main body case 48. The first printing apparatus 50a is connected to the main body case 48, and the second printing apparatus 50b is connected to the first printing apparatus 50a (interface unit 51), respectively, through cables 63, 67. Instead of the illustrated example, the arrangement may be made arbitrarily within a limit allowable by the cable length.

The terminal computer 40 has disposed on a front upper portion of the main body case 48 a keyboard 43 which is used by the operator in inputting the input information relating to the commodities and, on a rear right side thereof, an operator-use display 42a for the operator to confirm the input information. Inside the main body case 48 there is housed a cash drawer 49. On a right-side side surface of the main body case 48, there is connected through a cable a bar code reader 44 which is used for reading a bar code adhered to, or printed in advance on, the commodity. On the left-side side surface of the main body case 48, there is provided a terminal interface 47 which is used for connection with the printing apparatus 50. On the right side of the keyboard 43, there is formed a card reader slot 45 for reading the credit card presented by the customer 100. On the rear-surface side of the main body case 48, there is disposed a customer-use display 42b which is used by the customer 100 in confirming the purchased commodity name, the amount to be paid, and the like.

The first printing apparatus 50a, on the other hand, has mounted the interface unit 51 on a mounting slot (interface substrate slot) 59 which lies in the front side thereof. The interface unit 51 and the terminal computer 40 are connected together through the terminal interface 47 and the host computer interface 52. The interface unit 51 and the IP server 70 are connected together through the IP server interface 54 (connection cable not shown). The interface unit 51 and the second printing apparatus Sob are connected together through the printing apparatus interface 52 and the second printing apparatus interface 57. On an upper surface of the first printing apparatus 50a, there is formed a receipt discharging slit 64a for discharging the printed paper 61a. Similarly, on an upper surface of the second printing apparatus 50b, there is formed a receipt discharging slit 64b for discharging the printed paper 61b. In close proximity to these receipt discharging slits 64a, 64b of the first printing apparatus 50a and the second printing apparatus 50b, there are provided paper-cutting mechanisms (not shown) for cutting the paper 61a, 61b. The cut paper 61a, 61b can thus be handed over to the customer. Although the details are omitted, the control and performance of the cutting operation by means of the paper-cutting mechanism are made as a result of receiving of the paper-cutting command contained in the first print data or the second printing command.

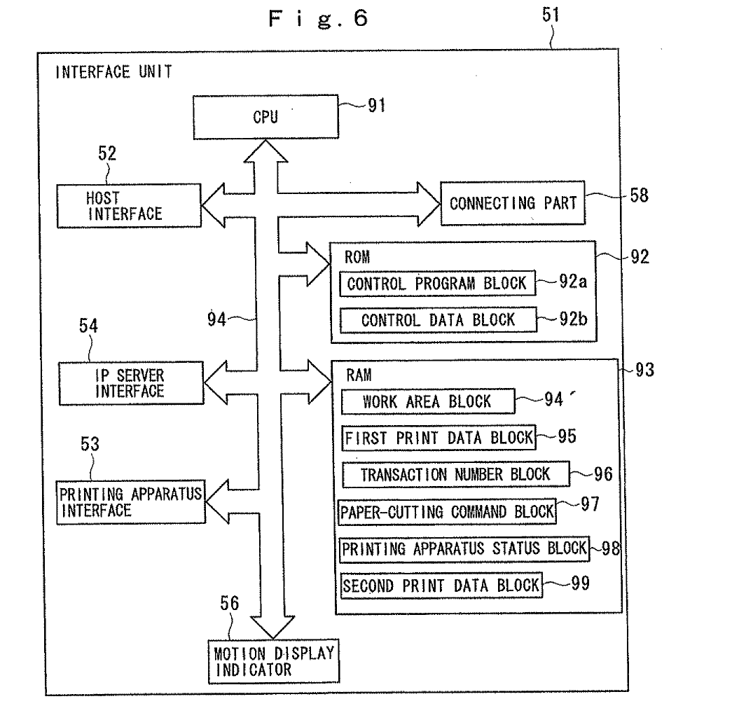

As shown in FIG. 3, the interface unit 51 has disposed therein: a host interface 52 on the front surface; an IP server interface 54; a printing apparatus interface 53; and a motion display indicator 56. The motion display indicator 56 is to indicate the operating conditions of the interface unit 51, and is made up of an LED which is lighted up or flashed. The interface unit 51 is provided in the center thereof with a control substrate 157 having a memory (see FIG. 6) such as a ROM 92, a RAM 93, and the like, as well as a CPU 91 and, in the rear portion thereof, with a connecting part 58 (connector) for connection to the main body (print-processing part 60) of the first printing apparatus 50a. The host interface 52, the IP server interface 54, the printing apparatus interface 53, the connecting part 58, and the motion display indicator 56 are connected to the control substrate 157 by means of a bus.

The host interface 52 and the IP server interface 54 may be employed to comply with the standards for serial file transmission such as RS-232 standard, parallel data transmission such as Centronics standard, network connection such as 10Base-T of Ethernet (reg. trademark), or data transmission standards such as USB (FIG. 3 shows an example in which UM is used as the host interface 52, and 10Base-T is used as the IP server interface). The above-described plurality of interfaces need not be physically plural in number. Like Ethernet (reg. TM) which has physically only one connector, an arrangement can be made inside the interface unit 51 for theoretical recognition as a plurality of interface ports.

The first print data received from the terminal computer 40 can be transferred to the IP server 70 by employing a protocol such as File Transfer Protocol (FTP), User Datagram Protocol (UDP), and the like. In case FTP is employed on the Ethernet (reg. TM), the reliability is higher than the case with the UDP and, in case the UDP is employed, the transfer speed is higher than the case with the FTP.

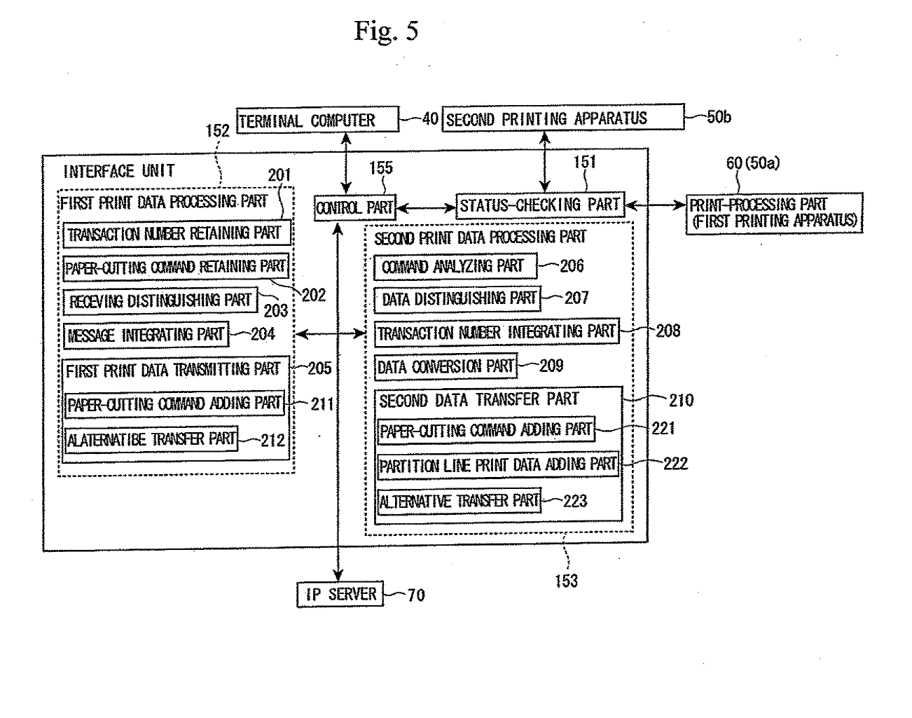

Next, a description will now be made about the functions of the terminal computer 40, the printing apparatus 50 (interface unit 51), and the IP server 70 (i.e., the arrangement or configuration of the printing system according to the invention) with reference to the function block diagrams in FIGS. 4 and 5.

As shown in FIG. 4, the terminal computer 40 is provided with a first print data generating part 141 for generating the first print data and the first print data transmitting part 142 for transmitting the generated first print data. The first print data generating part 141 sets transaction number (receipt issue No.) which varies from settlement to settlement, and generates the first print data inclusive of the transaction number. Although the details are described hereinafter, the transaction number is transferred to the print-processing part 60 as a part of the first print data in the interface unit 51 and, at the same time, is retained in the interface unit 51 for further building-in into the second print data received from the IP server 70. As a result, the transaction number is printed also in the coupon (see FIG. 9).

On the other hand, the first printing apparatus 50a has, as main elements, the interface unit 51 and the print-processing part 60 (first printing apparatus 50a main body). The interface unit 51 is made up of a status-checking part 151 which checks whether the print-processing part 60 and the second printing apparatus 50b are operating properly; the first print data processing part 152 which issues print command by transferring the first print data received from the terminal computer 40 to the print-processing part 60; a second print data processing part 153 which analyzes the second print data received from the IP server 70 and, depending on the result of the analysis, or depending on the result of monitoring by the status-checking part 151, transfers the second print data to the print-processing part 60 or to the second printing apparatus 50b; and a control part 155 which controls each of these parts. The control part 155 has, as a main constituting element, the CPU 91 (see FIG. 6) which is described hereinafter and performs an overall control over the interface unit 51. The detailed functions of the interface unit 51 are described hereinafter with reference to FIG. 5.

The print-processing part 60 is made up of a print control part 55, a data storage part 80a, and a printing part 85 having a print head (not shown). The data storage part 80a is provided with a receiving buffer 81 which receives the print data and various control commands. The print-processing part 60 performs print control by developing the data stored in the receiving buffer 81 into a data format which can be transmitted to the printing part 85. The second printing apparatus 50b also has an arrangement which is similar to that of the print-processing part 60 of the first printing apparatus 50a. The description thereof is therefore omitted.

On the other hand, the IP server 70 is made up of: a second print data generating part 171 which analyzes the first print data received from the start of receiving of the first print data from the interface unit 51 to the end of receiving (receiving of command to cut paper) to thereby generate the second print data; and a second print data transmitting part 172 which transmits the generated second print data to the interface unit 51.

When the first print data is received from the interface unit 51, the second print data generating part 171 generates the second print data by referring to the advertising and sales promotion information table (advertising and sales promotion information block 74, see FIG. 1). In concrete, out of the advertising and sales promotion information table in which the commodity code (or commodity name) to be included in the first print data and the advertising and sales promotion information data (or advertising and sales promotion information code to specify each of the advertising and sales promotion information data) for generating the second print data are stored in co-relationship with each other, the advertising and sales promotion information data relating to the commodity code included in the first print data is all extracted. The extracted advertising and sales promotion information data is synthesized (listed) in the order of extraction, to thereby generate the second print data. In case the advertising and sales promotion information data relating to the commodity code included in the first print data is not present, the second print data transmitting part 172 does not generate the second print data, but transmits to the interface unit 61 the status data (non-transmission status data) to that effect.

Now, with reference to FIG. 5, a description will be made about the function of the interface unit 51. As shown in FIG. 5, the status-checking part 151 of the interface unit 51 monitors the status by utilizing the functions originally owned by each of the printing apparatuses 50a, 50b (i.e., the functions to transmit to the terminal computer 40 the internal state or status of its own). Instead of picking up the status, it may be so arranged that the command is periodically transmitted to each of the printing apparatuses 50a, 50b for the purpose of status confirmation so as to monitor the status depending on the response therefrom. As the status to monitor, there can be listed up the check items such as “paper failure?,” “paper jamming?,” “no ink, no toner?,” “power ON?,” “cover left open? (in case the printing apparatus has a printer cover),” and the like.

The first printing date processing part 152 of the interface unit 51 is made up of: a transaction number retaining part 201 which retains the transaction number included in the first print data as received from the terminal computer 40; a paper-cutting command retaining part 202 which retains the paper-cutting command included in the first print data; a receiving distinguishing part 203 which distinguishes whether the second print data is received from the IP server 70; a message integrating part 204 which integrates a predetermined message into the first print data depending on the result of judgment by the receiving distinguishing part 203; and a first print data transmitting part 205 which transmits the received first print data as it is or with a predetermined processing (with or without processing).

The transaction number retaining part 201 extracts the transaction number and the bibliographical matters out of the first print data to be transmitted to the print-processing part 60, and then copy them for subsequent retaining thereof. Therefore, inside the first print data to be transmitted by the first print data transmitting part 205 to the print-processing part 60, there remain the transaction number and the bibliographical matters (see FIG. 9, and the like).

The paper-cutting command retaining part 202 extracts the paper-cutting command out of the first print data to be transmitted to the print-processing part 60, and cut it for subsequent retaining thereof. Ordinarily, in a printing apparatus in which the length of paper varies with the amount of settlement information like in the receipt printing apparatus, there is required a predetermine code showing the end of the printing. The paper-cutting command is added to the end of the print data in one transaction. Therefore, in this example, there is included a paper-cutting command at the end of the first print data. Therefore, when the first print data is received (in case the data is received from the host interface 52), search and extraction are made of this paper-cutting command. The paper-cutting command as retained in the paper-cutting command retaining part 202 is processed, depending on the result of analysis of the second print data, by the paper-cutting command adding part 211, 221 as described in detail hereinafter.

The receiving distinguishing part 203 distinguishes whether the second data should be received or not by receiving the from the IP server 70 the non-transmission status or the second print data itself. In stead of receiving the non-transmission status from the IP server 70, in case the second print data is not received within a predetermined time, judgment may be made that the second print data is not printed.

Even in case the second data is judged to have been transmitted by the receiving distinguishing part 203 and also in case the data analyzing part 206 analyzes that the color command is included in the second print data, the message integrating part 204 integrates to the first print data the message print data which is for printing the message (see FIG. 9, and the like) to the effect that a coupon is issued (“coupon is issued”). Because the coupon is issued from the second printing apparatus 50b in case the color command is included in the second print data, the operator and the customer 100 is reminded not to forget to obtain the coupon.

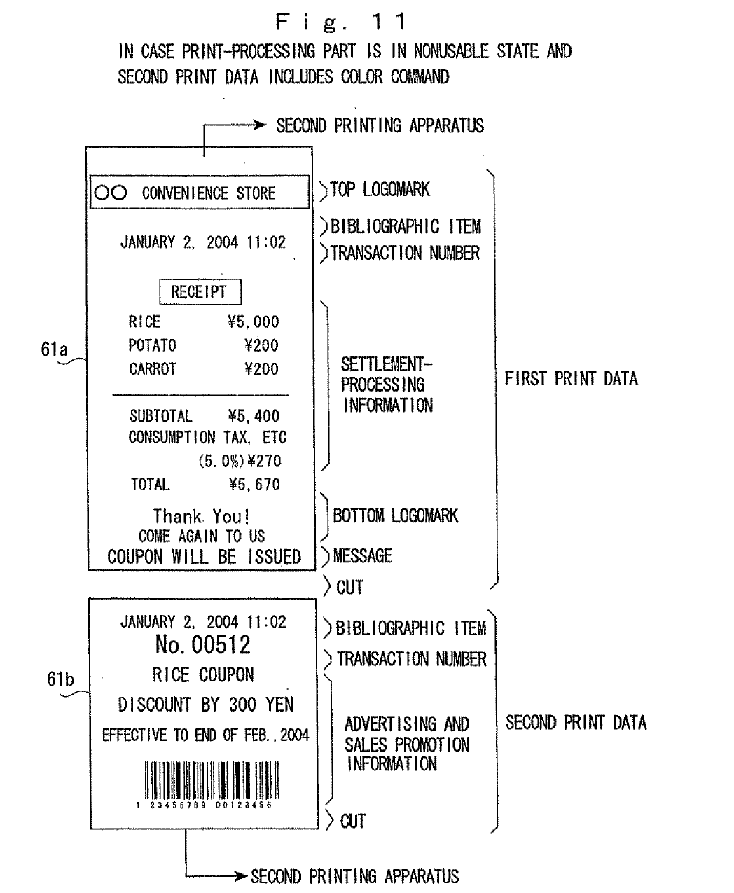

The first print data transmitting part 205 is provided with: a paper-cutting command adding part which adds the retained paper-cutting command to the first print data; and an alternative transfer part 212 which transfers the data to the second printing apparatus 50b in case the print-processing part 60 cannot be used. When the data analyzing part 206, which is described hereinafter, analyzes that a color command is included in the second print data, the paper-cutting command adding part 211 transfers, at that point of time, the paper-cutting command to the print-processing part 60. In case the transfer of the first print data has not been finished at this point of time, the paper-cutting command is integrated at the end of the first print data. In case the print-processing part 60 is judged to be in a state not for use from the result of analysis by the status-checking part 151, the alternative transfer part 212 transfers the first print data which is to be transferred to the print-processing part 60, to the second printing apparatus 50b. In this case, regardless of whether the color command is contained in the second print data or not, the second printing apparatus 50b issues the receipt and the coupon in a state separated from each other (see FIG. 11).

On the other hand, the second print data processing part 153 of the interface unit 51 is made up of: a command analyzing part 206 which analyzes the command in the second print data as received from the IP server 70; a data distinguishing part 207 which distinguishes, based on the analysis result by the command analyzing part 206, whether the second print data can be printed by the first printing apparatus 50a; a transaction number integration part which builds in the transaction number retained in the transaction number retaining part 201 to the second print data; a data conversion part 209 which converts the color print data into black-and-white print data when alternative transfer of the color print data becomes necessary; and a second print data transfer part 210 which transfers the second print data with predetermined processing to the print-processing part 60 or to the second printing apparatus 50b.

The command analyzing part 206 analyzes the command contained in the second print data and, in case a color command is contained therein, judges that the second print data is color print data.

The color command is interpreted, depending on the parameter, to be the color like the first color and the second color, or a specific color like yellow (Y), magenta (M), cyan (C), black (K), and the like, and the subsequent color is interpreted to remain the designated color until the next color command is transmitted. In addition, in case of the text data, the data is segmented by the predetermined unit of a character, a line, and the like. The data is added by the color command and is transmitted. In case the data is transmitted by the unit of line and in case different colors are present in a mixed manner in the same line, data of various colors within the same line is transmitted such that overlapped printing is made in the same line without line shifting. Further, in case of bit image, the image is segmented into a suitable size (e.g., within a predetermined range in the feeding direction of the paper), thereby transmitting data of various colors. In this case, various colors are arranged to be printed by synthesizing inside the print-processing part 60 and the second printing apparatus 50b.

In case a judgment is made, depending on the analysis by the command analyzing part 206, that the color command is included in the second print data, the data distinguishing part 207 distinguishes that the second print data cannot be printed by the first printing apparatus 50a which is the black-and-white printing apparatus. Therefore, in case the color command is included in the second print data, the second print data is transferred by the second print data transfer part 210 to the second printing apparatus 50b based on the judgment.

The transaction number integrating part 208 serves to integrate the transaction number and the bibliographical matters retained in the transaction number retaining part 201 into a predetermined position in the second print data. The position of integrating the transaction number and the bibliographical matters is the respectively determined set positions. In this embodiment, in order to make the transaction number more conspicuous, the character sizes are enlarged before integrating (see FIG. 9). At this time, it is possible to change not only the character sizes but also the character colors, or to further provide the characters with a predetermined decoration.

The data conversion part 209 functions to convert the color print data of the second print data into black-and-white print data when the second print data is judged to contain the color command and when it is judged, from the monitor result by the status-checking part 151, to be impossible for the second printing apparatus 50b to perform printing. This color conversion is materialized by deletion of the color command or by rewriting.

The second print data transfer part 210 is made up of: a paper-cutting command adding part 221 which adds a paper-cutting command to the end of the second print data; a partition line print data adding part 222 which adds a partition line print data for printing a partition line to the head of the second print data; and an alternative transfer part 223 which transfers the data to the other printing apparatus in case the printing apparatus (the print-processing part 60 or the second printing apparatus 50b) to which the second print data is to be transferred.

The paper-cutting command adding part 221 functions to add the paper-cutting command retained in the paper-cutting retaining part 201 to the end of the second print data. The partition line print data adding part 222 adds partition line print data for printing dotted lines to the head of the second print data, to clarify the border between the first print data and the second print data, in case the second print data is judged by the data distinguishing part 207 to be capable of being printed by the print-processing part 60. In addition, the alternative transfer part 223 functions to alternatively transfer the second print data to the other printing apparatus, in case the place where the second print data is determined to be transferred depending on the result of analysis by the command analysis part 206, has been judged to be in a state of not available for use as a result of monitoring by the status-checking part 151.

According to the above-described arrangement, the control part 155 functions as follows, i.e., when the first data is received from the terminal computer 40, the first data received from the terminal computer 40 is transferred by the first print data transmitting part 205 to the IP server 70 as it is (without message, with paper-cutting command), and also the transaction number, bibliographical matters, and paper-cutting command are extracted and retained by the transaction number retaining part 201 and the paper-cutting command retaining part 202 out of the first print data transferred to the print-processing part 60. In addition, depending on the result of distinction by the receiving distinguishing part 203, the control part 155 functions to integrate by the message integrating part 204 a predetermined message into the first print data depending on the result of distinction by the receiving distinguishing part 203, and functions to transfer, by the first print data transfer part 305, the first print data to the print-processing part 60. At this time, in case the print-processing part 60 is judged by the print-processing part 60 to be incapable of use, the first print data is transferred to the second printing apparatus Sob. The control part 155 further functions, i.e., when the second data is received from the IP server 70, the command in the second print data is analyzed by the command analyzing part 206 and, based on the result of analysis, a distinction is made by the data distinguishing part 207 as to whether the second print data can be printed by the first printing apparatus 50a. In addition, the control part 155 functions to perform, by the transaction number integrating part 208, the data conversion part 209, and the second print data transfer part 210, predetermined processing such as adding the transaction number, partition line print data, paper cutting command, and the like, aside from the color conversion of the second print data and, transfers the second print data to the targeted place of transfer (the print-processing part 60 or the second printing apparatus 50b) depending on the result of distinction by the data distinguishing part 207. At this time, in case the print-processing part 60 or the second printing apparatus 50b has been distinguished, by the status-checking part 151, to be incapable of use, the control part 155 transfers the second print data to the other printing apparatus.

Now, with reference to the control block in FIG. 6, a description will be made about the control arrangement of the interface unit 51. As shown in FIG. 6, the interface unit 51 has the motion display indicator 56, the CPU 91, the ROM 92, the RAM 93, aside from the above-described host interface 52, the IP server interface 54, and the printing apparatus interface 58. They are connected to one another by an internal bus 94. The motion display indicator 56 is constituted by an LED and is lighted up when some kind of processing is being performed in the interface unit 51. In case an error happens to the interface unit 51, it is arranged to blink.

The ROM 92 has a control data block 92b which stores therein the control data inclusive of various tables, aside from the control program block 92a which stores therein the control program for processing by the CPU 91. Message print data which prints the message to the effect that the second print data is printed (coupon is issued), and a partition line print data are stored in the control data block 92b.

Aside from the various work area block 94′ to be used as a flag, and the like, the RAM 93 has: a first print data block 95 which stores therein the first print data received from the terminal computer 40; a transaction number block 96 which stores therein extracted from the first print data; a paper-cutting command block 97 which stored therein the paper cutting command extracted from the first print data; a printing apparatus status block 98 which stores therein the printing apparatus status which is the result of monitoring of the print-processing part 60 and the second printing apparatus 50b; and a second print data block 99 which stores therein the second print data received from the IP server 70. The RAM 93 is used as a working area for the control processing.

The internal bus 94 integrates the input data such as the first print data, the second print data, the printing apparatus status, and the like, from the I server interface 54, the printing apparatus interface 53, and the connecting part 58. The internal bus 94 also outputs the data and control signal outputted from the CPU 91, and the like, into the terminal computer 40, the IP server 70, the second printing apparatus 50b, the print-processing part 60, and the like, through each of the above-described interfaces 52, 53, 58.

According to the above-described arrangement, the CPU 91 inputs various signals, data, and the like from each part inside the interface unit 51 and processes various data, and the like inside the RAM 93 based on the control program inside the ROM 92. The CPU 91 thus also performs a control of the entire interface unit 51 such as transferring the print data (transmission and receiving) of the print data by outputting various signals, data, and the like to each part.

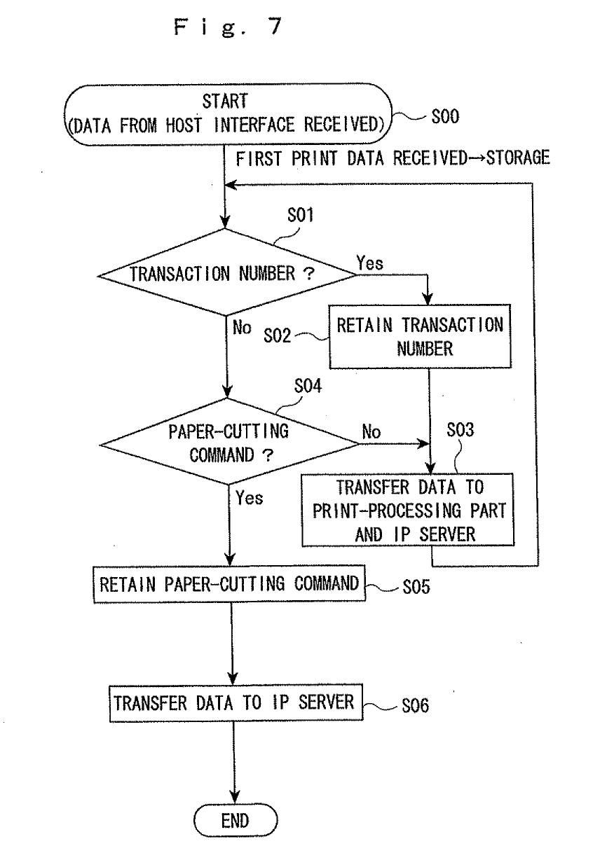

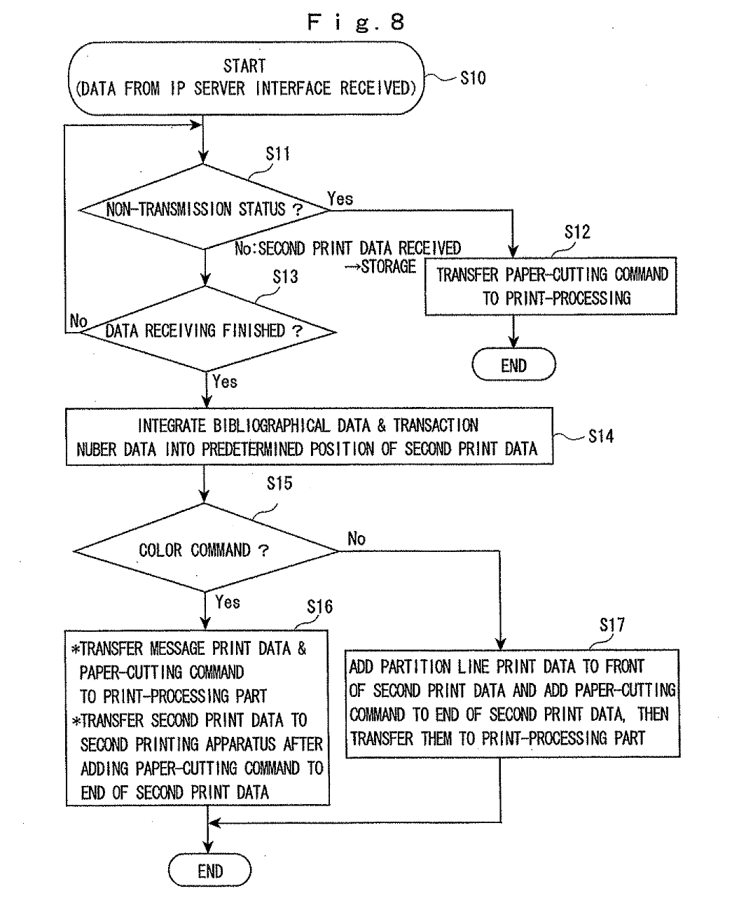

Now, with reference to the flow chart in FIGS. 7 and 8, a description will be made about the processing of the interface unit 51 which is controlled mainly by the above-described CPU 91. FIG. 7 shows the processing which makes a trigger of the data receiving from the host interface 52 and FIG. 8 shows the processing which makes a trigger of the data receiving from the IP server interface 54. The interface unit 51 is defined to receive and analyze the data by the unit of each line of both the first print data and the second print data. In addition, in order to facilitate the understanding, the result of analysis of the status-checking part 151 (see FIG. 4) is defined to be that both the print-processing part 60 and the second printing apparatus 50b are capable of being printed.

As shown in FIG. 7, when data is received from the host interface 52 (S00), the CPU 91 determines the data to be the line data of the first print data and temporarily stores the data into the first print data block 95, and distinguishes whether the transaction number is included in the line data (S01). As to whether the transaction number is included or not can be distinguished by character string search with wild card, and the like and, in case a particular command is added to the transaction number, by the presence or absence of that particular command. When a judgment is made that the particular command is included (S01: Yes), the transaction number is retained in the transaction number block 96 (S02), and the line data is transferred to the print-processing part 60 and the IP server 70 (S03).

When a judgment is made that the transaction number is not included (S01: No), a distinction is made as to whether a paper-cutting command is included or not (S04). This distinction is made based in whether the command coincides or not. When a judgment is made that the paper-cutting command is not included (S04: No), the line data is transferred as it is to the print-processing part 60 and the IP server 70 (S03). When a judgment is made that the paper-cutting command is included (S04: Yes), the paper-cutting command is retained in the paper-cutting command block 97 (S05), and the line data is transferred to the IP server 70 (S03).

Next, a description will now be made about the flow chart in FIG. 8. When data is received from the IP server interface 54 (S10), the CPU 91 distinguishes as to whether or not the data is in non-transmission status in which the second print data is not transmitted from the IP server 70 (S11). This distinction is made based on whether the status command coincides or not. Here, when a judgment is made that the data is in the non-transmission status (S11: Yes), the paper-cutting command retained in the paper-cutting command block 97 is transferred to the print-processing part 60 (S12), and the processing is finished. In this case, only the receipt (61a) as shown in FIG. 9 is issued by the first printing apparatus 50a and the coupon is not issued (the second print data is not printed).

When a judgment is made that the data is not in the non-transmission status (S11: No), a determination is made that the data is the line data of the second print data and is stored in the second print data block 99. Further, a distinction is made as to whether the receiving of the second print data has been finished or not (S13) and, when it has been finished (S13: Yes), the data of bibliographical matters and the data for printing the transaction number are integrated into the predetermined position for the second print data (S14). The fact that the second print data has been received (S13) can be distinguished by the receiving of the bar code data (see FIG. 9). By the way, in this embodiment, at the head of the second print data (before the advertising and sales promotion information), the bibliographical data and the transaction number are integrated in the order mentioned (see FIG. 9). Therefore, without waiting for the completion of the data receiving, it may be so arranged that, when the first line of the second print data has been received, the data for printing the bibliographical matters and the transaction number may alternatively be integrated for storing such data into the second print data block 99. In step 814 in order to clarify the transaction number to the customer and the operator, the transaction number is integrated by enlarging the font size thereof. The bibliographical matters and the transaction number are defined to be of black-and-white print data.

When the data has been integrated (814), the command of the second print data stored in the second print data block 99 is analyzed to distinguish whether a color command is included in the second print data (S15). This distinction may be made at every receiving of the line data without waiting for the completion of receiving of the second print data.

When the distinction has been made that the second print data contains therein the color command (816: Yes), the message print data stored in the control data block 92b and the paper-cutting command retained in the paper-cutting command block 97 are transferred to the print-processing part 60, and also the second print data is transferred to the second printing apparatus 50b after adding the paper-cutting command to the end of the second print data (S16), thereby finishing the processing. The result of printing in this case is as shown in FIG. 9. The receipt 61a is issued by the first printing apparatus 50a and the coupon 61b (printed in color) is issued by the second printing apparatus 50b.

In case a distinction id made that the color command is not contained in the second print data (S15: No), the partition line print data stored in the control data block 92b is added to the front of the second print data, and the paper-cutting command retained in the paper-cutting command block 97 is added to the end of the second print data before transferring to the print-processing part 60 (S17), thereby finishing the processing. The result of printing in this case is shown in FIG. 10, in which the receipt 61a with coupon (all printed in black-and-white) is issued by the first printing apparatus 50a. In case the receipt and the coupon (the first print data and the second print data) are printed consecutively like this, the message to that effect is not printed even in case the coupon is issued.

In the flow chart shown in FIG. 7, the first print data as received from the terminal computer 40 is defined to be transferred to the print-processing part 60 and the IP server 70 for every line data. It may alternatively be so arranged that the transfer may be made after the interface unit 51 has received all the first print data into the first print data block 95. In addition, it may alternatively be so arranged that, the first print data is not transferred until receiving of the non-transfer status from the IP server 70 or the second print data, the transfer of the first print data is not performed, and that a distinction is made, subject to the receiving thereof, as to whether the message print data shall be integrated or not and, depending on the result of the distinction, the first print data with due processing is transferred.

In the above-described embodiment, the result of monitoring of the status checking is assumed to be of printable state to in both the print-processing part 60 and the second printing apparatus 50b. In case the print-processing part 60 is incapable of use and in case the color command is included in the second color command, both the first print data and the second print data will be issued from the second printing apparatus 50b as shown in FIG. 11 (paper 61b). In this case, since the first print data to be transferred to the first printing apparatus 50a is transferred to the second printing apparatus 50b, the first print data and the second print data are printed in a segmented state. In addition, in case the color command is not included in the second print data, the first print data and the second print data are printed sequentially by the second printing apparatus 50b as shown in FIG. 10.

Further, in case the second printing apparatus 50b is in a state of being incapable of use and in case the color command is included in the second print data, the first print data and the second print data are printed in a segmented state as shown in FIGS. 9 and 11, and the second print data is converted into the black-and-white print data. In case the color command is not included in the second print data, there is no printing performed by the second printing apparatus 50b. Therefore, there occurs no problem even in case of being incapable of use (as shown in FIG. 10, the receipt and the coupon are issued by the first printing apparatus 50a).

As described hereinabove, according to the embodiment, the interface unit 51 can analyze the second print data received from the IP server 70 and the second print data can be printed by the first printing apparatus 50a. In other words, in case judgment is made that only the black-and-white print data is included, the second print data is transferred to the print-processing part 60 (first printing apparatus 50a). In case a judgment is made that the printing cannot be made by the print-processing part 60, i.e., in case a judgment is made that a color command is included, the second print data is transferred to the second printing apparatus Sob. Therefore, not only the first print data but also the second print data can be printed by the black-and-white printer, i.e., the first printing apparatus 50a. In this manner, by ordinarily using the first printing apparatus 50a which is relatively higher in printing speed, an overall tact time required for print processing of the first print data and the second print data can be shortened. This results in that the advertising and sales promotion information can be efficiently provided to the customer 100.

Further, the interface unit 51 is arranged to be mounted on, or detached from, the mounting slot 59 (see FIG. 1) of the first printing apparatus 50a, and can perform the transfer of the first print data to the IP server 70. Therefore, only by mounting the interface unit 51, there can be added the function of issuing the advertising and sales promotion information ticket without the necessity of modifying the terminal computer 40 or of changing the POS application 146. The POS system 10 according to this embodiment can thus be easily constructed.

Further, in case the second print data is transferred to the print-processing part 60, the interface unit 51 adds the paper-cutting command to the rear end of the second print data. Therefore, the first print data and the second print data can be sequentially printed and, further, the rear end of the paper 61a can be automatically cut by the paper-cutting mechanism. According to this arrangement, the operator can only hand over a piece of automatically cut paper to the customer 100, thereby reducing the load on the operator. Further, in case the second print data is transferred to the second printing apparatus 50b, only the paper-cutting command is transferred to the print-processing part 60, and the paper-cutting command is added to the rear end of the second print data. Therefore, even in case printing is performed by two printing apparatuses, the pieces of paper 61a, 61b which are adequately cut automatically by the paper-cutting mechanism can be issued by both the printing apparatuses 50a, 50b.

In addition, the interface unit 51 transfers the first print data inclusive of the bibliographical matters and the transaction number to the print-processing part 60. The interface unit 51 also extracts the bibliographical matters and the transaction number and temporarily retains them to thereby integrate the data for printing the bibliographical matters and the transfer number into the second print data as received from the IP server 70. Therefore, the paper on which the first print data is printed and the paper on which the second print data is printed can be co-related to each other by the transaction number even in case the first print data and the second print data are printed by separate printing apparatuses or in case both the print data are printed by the same printing apparatus but are printed in a manner separated from each other. Therefore, even in case the second printing apparatus 50b is disposed in a position apart from the first printing apparatus 50a so that the paper (advertising and sales promotion information) to be issued by the second printing apparatus 50b is received by the customer 100 like in this embodiment, a confirmation can be made as to whether the transaction number coincides with each other. By doing so, it can be prevented for the customer from wrongly receiving the other's paper by mistake or for the customer from wrongly receiving the other's paper, or for the operator from wrongly handing over the other's paper to the wrong customer.

In case the status of the print-processing part 60 and the second printing apparatus 50b is checked and judgment is made that one of them is not in operation, the print data is transferred alternatively to the other printing apparatus. Therefore, even in case any one of the print-processing part 60 and the second printing apparatus 50b is not in good order, the print processing of the first print data and the second print data can be performed without any problem. In addition, in case the color command is included in the second print data and in case the printing apparatus to which the print data is alternatively transferred is black-and-white printing apparatus, the color print data is converted to the black-and-white print data, thereby enabling to process as black-and-white print data.

Further, in case the color command is included in the second print data, the interface unit 51 performs printing by integrating into the first print data a message to the effect that a coupon will be issued. The operator and the customer 100 are therefore able to know from the message that the second printing message will be issued. In addition, the operator and the customer can be prevented from failing to pick up the coupon.

In the above-described embodiment, the description was made about an example in which two printing apparatuses of the first printing apparatus 50a and the second printing apparatus 50b are used. It may, of course, be so arranged that three or more printing apparatuses are used. In this case, the printing apparatuses may be given priority sequence so that the second print data can be transferred in accordance with the priority sequence. In addition, in case three or more printing apparatuses are used, the printing apparatus which is alternatively used when the second printing apparatus cannot be used may be determined in advance such that, e.g., in case the first printing apparatus is in a state of incapable of use, the n-th printing apparatus is used and that, in case the second printing apparatus is in a state of incapable of use, the m-th printing apparatus is used.

In the above-described example, a description was made about an example in which the first printing apparatus 50a for black-and-white printing and the second printing apparatus 50b for color printing were used. Modification may, of course, be made such that, depending on the kind and content of the first print data and the second print data, the first printing apparatus 50a is set to perform printing of two colors or less and the second printing apparatus 50b is set to perform printing of three colors or more. Preferably, the first printing apparatus 50a meets the requirement that the processing speed is higher than the second printing apparatus 50b and that the running cost is smaller, and the like.

In the above-described example, the interface unit 51 is defined to transfer the first print data to the IP server 70. It may, of course, be so arranged that the first print data is transferred to the IP server 70 from the POS server 30 or from the terminal computer 40 like in the conventional POS system.

Also in the above-described example, the first print data generated by the POS application 146 is defined to include the paper-cutting command. It may also be so arranged that, in case the POS application 146 generates the first print data which does not contain the paper-cutting command, the paper-cutting command may be added to the end of the first print data by means of the printer driver 147 or by the interface unit 51.

Further, in the above-described example, the bibliographical matters extracted from the first print data, and the transaction number are defined to be integrated into the second print data (see FIG. 9). However, in case the first print data contains therein personal information (result of reading a membership card or a credit card, and the like by means of the card reader 45 as shown in FIG. 1 of the terminal computer 40), the personal information may be extracted for integrating into the second print data. According to this arrangement, the customer 100 can more effectively be prevented from wrongly picking up the paper.

Further, in the above-described embodiment, there was employed an arrangement in which, in case the second print data contains color command, the first print data and the second print data are printed in a state separate from each other (see FIG. 11). In case both the data are printed by the same printing apparatus based on the result of monitoring the status of the printing apparatus, both the data may be printed in a consecutive manner without adding the paper-cutting command to the first print data. In this case, too, preferably a partition line is printed in the border between the first print data and the second print data. Also in this case, the printing of the message may be omitted.

In the above-described embodiment, the description was made about an example in which the printing system of the invention is applied to the POS system 10. However, the invention can be applied to any printing system which has at least: an interface unit capable of receiving two data which are different from each other in characters; and a plurality of printing apparatuses which perform print processing of the data as obtained through the interface unit. In other words, the first print data and the second print data may vary in kind and contents, and the terminal apparatus to provide these data may also vary in kind.

In addition, in the above-described embodiment, the interface unit 51 is defined to have two receiving communication ports (host interface 52 for the IP server 70 to be connected to the terminal computer 40, and the IP server interface 54 to be connected to the IP server 70). It may, of course, be so arranged that the first print data and the second print data are received from a single communication port through a hub, and the like. In this case, an ID is set to each host apparatus (terminal computer 40 and/or the IP server 70) so as to transmit the ID to the interface unit 51 by adding the ID to each print data. In this manner, the interface unit 51 can distinguish which data the obtained print data belongs. Further, the first print data has added thereto the paper-cutting command. Therefore, there may be used a method in which, when the command in question is detected, the data is judged to be the first print data and, if not detected, the data is judged to be the second print data.

Further, in place of the interface unit 51, it is possible to cause an adaptor apparatus (connection device) having three communication ports (interfaces) to be connected to the terminal computer 40, the IP server 70, and the second printing apparatus 50b, to perform the functions in the interface unit 51.

Still furthermore, it is possible to provide each of the functions (each of the means) in the interface unit 51 as shown in both of the above-described embodiments, in the form of a program. The program can be stored in a memory medium (not shown) so as to be installed in a personal computer, and the like. In this manner, the invention can be materialized in others than in the POS system shown in this embodiment. As the storing medium, there can be used: a CD-ROM; a flash ROM; a memory card (compact flash, reg. TM, a smart media, a memory stick, and the like); a compact disc; an opto-magnetic disc; a digital versatile disc; a flexible disk; and the like.

Not limited to the above-described examples, the system constitution, apparatus arrangement, and the like of the invention can adequately be modified without departing from the substance of the invention

1-16. (canceled)

17. A printing system comprising:
a terminal computer that performs a settlement processing on a commodity data;
a first printer that prints a first print data inclusive of a settlement-processing information generated by the terminal computer;
a second printer that prints a second print data based on the first print data, inclusive of an advertising and/or sales promotion information when the second print data is received, wherein
the first printer prints by integrating into the first print data a message to the effect that the advertising and/or sales promotion information is issued from the second printer when the second printer is set to print the second print data.

18. The printing system according to claim 17, wherein
the second print data is transmitted to the second printer when a color command showing a color print data is contained in the second print data and the second printer prints the second print data.

19. The printing system according to claim 18, wherein
the first printer prints the first print data except the message and the second print data when the second print data is transmitted to the first printer.

20. The printing system according to claim 17 further comprising:
an information-providing server that inputs the first print data and that generates the second print data based on the first print data.

21. The printing system according to claim 20 further comprising:
an interface unit mounted on the first printer that has a communication port to communicate with the second printer and the information-providing server.

22. The printing system according to claim 19, wherein
the second printer that has a selector that sets a color printing mode or a black-and-white mode, and the first printer prints the first print data except the message and the second print data when the black-and-white printing mode is set in the second printer.

23. POS system comprising:
a POS terminal having
an input unit that inputs a commodity data;
a terminal computer that generates a first print data based on the commodity data and transmits the first print data;
an information-providing server that inputs the first print data, generates a second print data inclusive of a advertising and/or sales promotion information based on the first print data and transmits the second print data;
a first printer that prints a receipt based on the first print data;
a second printer that prints a coupon based on the second print data when the second print data is received, wherein
the first printer prints by integrating into the first print data a message to the effect that the coupon is issued from the second printer when the second printer is set to print the coupon.

24. The POS system according to claim 23, wherein
the second print data is transmitted to the second printer when a color command showing a color print data is contained in the second print data and the second printer prints the coupon based on the second print data.

25. The POS system according to claim 24, wherein
the first printer prints the receipt based on the first print data except the message and the coupon based on the second print data when the second print data is transmitted to the first printer.

26. A control method of a printing system comprising:
performing a settlement processing based on a commodity data;
generating a first print data inclusive of settlement-processing information based on the commodity data;
analyzing the first print data;
generating a second print data inclusive of an advertising and/or sales promotion information;
transmitting the first print data to a first printer and the second print data to a second printer; and
printing by integrating into the first print data a message to the effect that the advertising and/or sales promotion information is issued from the second printer using the first printer and printing the second print data using the second printer.
